(19) United States
(12) Patent Application Publication
(10) Pub. No.: US 2021/0248661 A1
(43) Pub. Date: Aug. 12, 2021

(54) IMAGE PROCESSING APPARATUS, IMAGE PROCESSING METHOD, PROGRAM, AND IMAGE PROCESSING SYSTEM

(71) Applicant: FUJIFILM Corporation, Tokyo (JP)

(72) Inventor: Kei YAMAJI, Tokyo (JP)

(73) Assignee: FUJIFILM Corporation, Tokyo (JP)

(21) Appl. No.: 17/150,484

(22) Filed: Jan. 15, 2021

(30) Foreign Application Priority Data
Feb. 12, 2020 (JP) 2020-021604

(51) Int. Cl. G06Q 30/06; G06K 9/00; G06K 9/62

(52) U.S. Cl. CPC G06Q 30/0631; G06K 9/6215; G06K 9/6267; G06K 9/00624

(57) ABSTRACT

Provided are an image processing apparatus, an image processing method, a program, and an image processing system capable of performing recommendation suggesting an appropriate product item for an image group based on a classification of the image group on time.

At least one processor of an image processing apparatus is configured to acquire a first image group, group the first image group into one or more groups according to image content of images included in the first image group, decide a recommended product item according to classifications of the groups based on date-of-acquisition information of the first image group and content of a second image group of the grouped groups, decide one or more images for use in creating the recommended product item from the second image group and a layout to create a candidate image corresponding to the recommended product item, and provide recommendation information regarding the recommended product item.

### CROSS-REFERENCE TO RELATED APPLICATIONS

The present application claims priority under 35 U.S.C § 119 to Japanese Patent Application No. 2020-021604 filed on Feb. 12, 2020. The above application is hereby expressly incorporated by reference, in its entirety, into the present application.

### BACKGROUND OF THE INVENTION

### 1. Field of the Invention

The present disclosure relates to an image processing apparatus, an image processing method, a program, and an image processing system, and in particular, to an image processing technique and a computer-related technique suitable for a computer system that performs recommendation of a product item using an image for a user who uses an image storage service.

### 2. Description of the Related Art

In recent years, there is known a photo cloud service in which data of photographs or video captured using imaging equipment, such as a smartphone or a digital camera, is stored in a cloud storage to manage a lot of images.

JP2014-007577A describes a system that creates a composite image corresponding to a photo product item, such as a photo book or a collage print, using images of a user stored in a storage of a server that provides a cloud service and provides the composite image to the user.

JP2016-167299A describes an image processing apparatus that automatically discriminates a theme of a predetermined image group included in a lot of images possessed by a user and suggests, to the user, a recommended photo product item corresponding to the theme of the image group based on the discriminated theme.

### SUMMARY OF THE INVENTION

In a case where recommendation of a product, such as a photo product item, is performed for a user who is a user of the photo cloud service, it is desirable to select an appropriate product item for an image group among a lot of image groups stored in the storage, create an image of a product item sample based on appropriate image selection and a layout corresponding to the product item, and suggests a recommended product item to the user at an appropriate timing.

The present disclosure has been accomplished in view of such a situation, and an object of the present disclosure is to provide an image processing apparatus, an image processing method, a program, and an image processing system capable of performing recommendation suggesting an appropriate product item for an image group based on a classification of the image group on time.

An aspect of the present disclosure provides an image processing apparatus comprising at least one processor. The at least one processor is configured to acquire a first image group, group the first image group into one or more groups according to image content of images included in the first image group, decide a recommended product item according to classifications of the grouped groups based on date-of-acquisition information of the first image group and content of a second image group of the grouped groups, select one or more images for use in creating the recommended product item from the second image group of the groups in conformity with the decided recommended product item, decide a layout of the one or more selected images to create a candidate image corresponding to the recommended product item, and provide recommendation information regarding the recommended product item to be created using the candidate image.

An image processing method according to another aspect of the present disclosure that is executed by at least one processor comprises, at the at least one processor, acquiring a first image group, grouping the first image group into one or more groups according to image content of images included in the first image group, deciding a recommended product item for a second image group of the grouped groups based on date-of-acquisition information of the first image group and content of the second image group of the grouped groups, selecting one or more images for use in creating the recommended product item from the second image group of the groups in conformity with the decided recommended product item, deciding a layout of the one or more selected images to create a candidate image corresponding to the recommended product item, and providing recommendation information regarding the recommended product item to be created using the candidate image.

A program according to another aspect of the present disclosure causes a computer to realize processing of acquiring a first image group, processing of grouping the first image group into one or more groups according to image content of images included in the first image group, processing of deciding a recommended product item for a second image group of the grouped groups based on date-of-acquisition information of the first image group and content of the second image group of the grouped groups, processing of selecting one or more images for use in creating the recommended product item from the second image group of the groups in conformity with the decided recommended product item, and deciding a layout of the one or more selected images to create a candidate image corresponding to the recommended product item, and processing of providing recommendation information regarding the recommended product item to be created using the candidate image.

An image processing system according to another aspect of the present disclosure comprises at least one server and a storage. The at least one server executes processing including receiving upload of a first image group from a user terminal through a network, storing the first image group acquired from the user terminal in the storage in association with user identification information, grouping the first image group into one or more groups according to image content of images included in the first image group, deciding a recommended product item for a second image group of the grouped groups based on date-of-acquisition information of the first image group and content of the second image group of the grouped groups, selecting one or more images for use in creating the recommended product item from the second image group of the groups in conformity with the decided recommended product item, deciding a layout of the one or more selected images to create a candidate image corresponding to the recommended product item, and providing recommendation information regarding the recommended product item to be created using a candidate image to the user terminal.

According to the aspects of the present disclosure, it is possible to provide recommendation information suggesting an appropriate product item for an image group according to a classification of the image group to a user on time.

### BRIEF DESCRIPTION OF THE DRAWINGS

FIG. 1 is a conceptual diagram showing a configuration example of an image processing system according to an embodiment of the present disclosure.

FIG. 2 is a flowchart showing the outline of the operation of the image processing system.

FIG. 3 is a diagram conceptually showing an example of screen transition on a display screen of a display of a user terminal.

FIG. 4 is an example of an image list screen.

FIG. 5 is an example of a folder list screen.

FIG. 6 is an example of an in-folder image list screen.

FIG. 7 is an example of a product item preview screen.

FIG. 8 is a chart exemplarily showing a kind of a photo product item to be a target of recommendation.

FIG. 9 is a chart in which a relationship between a condition of recommendation and a product item to be recommended is arranged.

FIG. 10 is a chart showing an example of an execution timing of processing by an image processing apparatus.

FIG. 11 is a diagram schematically showing a setting example of a logic validity period and recommendation display validity period.

FIG. 12 is a chart showing an example of a product item to be recommended according to classifications of a calendar event and a normal event.

FIG. 13 is a chart showing a specific example of a product item recommendation logic specification that is applied to the image processing apparatus.

FIG. 14 is a flowchart exemplarily showing a receipt operation of an image group by an image management server and an operation of image analysis by an image processing server and folder creation by the image management server.

FIG. 15 is a flowchart exemplarily showing an operation of determination on whether or not it is within a logic validity period in a recommendation server.

FIG. 16 is a flowchart exemplarily showing an operation regarding recommendation logic processing and an operation regarding recommendation display.

FIG. 17 is a flowchart exemplarily showing an operation regarding display of the product item preview screen.

FIG. 18 is a display example of an order screen.

FIG. 19 is a block diagram showing an example of the hardware configuration of a computer.

### DESCRIPTION OF THE PREFERRED EMBODIMENTS

Hereinafter, a preferred embodiment of the present disclosure will be described in detail referring to the accompanying drawings. In the specification, the same components are represented by the same reference numerals, and overlapping description will not be repeated.

Configuration Example of Image Processing System

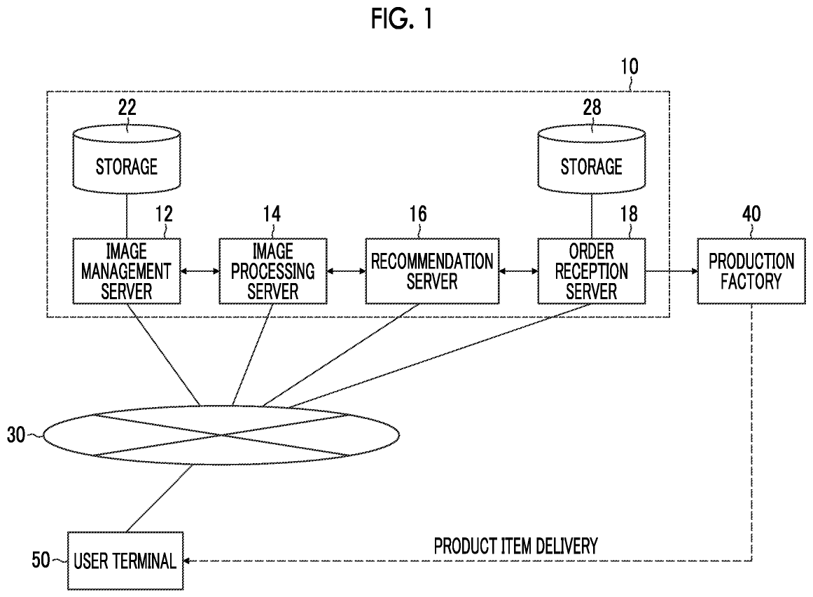

FIG. 1 is a conceptual diagram showing a configuration example of an image processing system according to an embodiment of the present disclosure. An image processing system 10 is connected to a user terminal 50 through a network 30. The image processing system 10 is, for example, a cloud computing system. The image processing system 10 stores images (first image group) uploaded from the user terminal 50. The image processing system 10 may provide various print related products using the stored images. The network 30 is an electric telecommunication line including the Internet.

The images (first image group) uploaded from the user terminal 50 may be static images, such as photographs or scanned images, may be video, or may be an image group captured at specific time intervals, such as continuous shooting or interval imaging A time interval of imaging in time series may not always be constant. A time interval of date information given for each image of the first image group may not always be constant. The date information given to each image of the first image group indicates date-of-image-acquisition information (date-of-imaging information or the like) that is recorded for each image as exchangeable image file format (Exif) information.

Various print related products include, for example, photo product items, such as a photo book, a photo calendar, and a design collage print. A product form of a photo product item may be a real product item, may be a virtual product item, or may be both of a real product and a virtual product. The real product item is a real printed matter product that is produced by printing based on data of a composite image created using data of a plurality of images in conformity with a specification of a product item, such as a photo book or a photo calendar. The real product item is produced in a production factory 40 and is delivered to an addressee corresponding to a user.

The virtual product item is a form in which data of a composite image created using data of a plurality of images in conformity with the specification of a product item, such as a photo book or a photo calendar is provided as a product in a form of data. The virtual product item may be downloaded through the network 30 and sold or data may be recorded in a portable external storage device represented by a digital versatile disc (DVD) or a memory card and the virtual product item may be provided in a form of the external storage device. The external storage device in which the virtual product item is recorded is produced at the production factory 40 and is delivered to an addressee corresponding to the user.

Note that, in the embodiment, although an example of a system that provides electronic commerce selling a photo product item in cooperation with a cloud storage will be described, a photo product item is not limited as being provided for a fee, and may be provided for free. The image processing system 10 is also referred to as a cloud storage or an online storage.

The image processing system 10 comprises an image management server 12, an image processing server 14, a recommendation server 16, and an order reception server 18. Although the configuration of each server is not shown in FIG. 1, each server comprises a processor and a memory. Each server may further comprise an input device and a display.

The image management server 12 is a server that receives upload of images from the user terminal 50 and stores and manages the images. The image management server 12 is, for example, a cloud storage server. The image management server 12 comprises a storage 22. The image management server 12 is connected to the network 30, stores the images uploaded from the user terminal 50 through the network 30 in the storage 22, and manages the images.

The image management server 12 can store a plurality of images corresponding to a plurality of folders. A plurality of folders correspond to, for example, an online album. The image management server 12 can divide a plurality of images into a plurality of image groups (groups), for example, based on user's designation or date information (date-of-imaging information), such as date given to each image, and can store each image group corresponding to one folder. The “album” is synonymous with the “folder”. The folder can be constructed in a hierarchical structure. One image may be associated with a plurality of folders. The image management server 12 can provide the image groups stored in the storage 22 to the user terminal 50 by way of the network 30.

The image management server 12 executes various kinds of processing in cooperation with the image processing server 14, the recommendation server 16, and the order reception server 18. The image management server 12 can acquire information generated by other servers, such as the image processing server 14, the recommendation server 16, and the order reception server 18, and can provide the acquired information to the user terminal 50.

The user terminal 50 is electronic equipment having a communication that is connectable to the network 30, and may be, for example, a mobile terminal, such as a mobile phone or a smartphone, a desktop personal computer (PC), a laptop PC, or a tablet PC. Although the configuration of the user terminal 50 is not shown, the user terminal 50 comprises a processor, a memory, an input device, and a display.

The user terminal 50 is a client terminal apparatus that is connected to the image processing system 10. The user can use the system by logging in to the image processing system 10 using the user terminal 50. For example, with the use of the user terminal 50, the user can upload images possessed by the user from the user terminal 50 to the image management server 12 through the network 30, can view images stored in the storage 22, a composite image (candidate image) of a photo product item created by the order reception server 18, or the like, can download images to the user terminal 50 through the network 30, or can make an order for the photo product item.

The image processing server 14 analyzes the images uploaded from the user terminal 50 and gives classification information according to image content to each image. The description “image content” includes concepts of imaging content, an imaging scene, an event or an activity where imaging is performed, a situation at the time of imaging, a kind of a subject, and the like. A plurality of pieces of classification information may be given to one image.

The image processing server 14 includes an artificial intelligence (AI) module that performs image recognition using an AI model. The AI module is configured using a learned model that is learned by deep learning. The AI module includes, for example, a convolutional neural network.

The description “image recognition” is not limited to class classification of an image and also includes a concept of object detection for detecting a position of an object and a class of the object from an image. The image processing server 14 performs image analysis using a scene recognition technique for performing image recognition in an image unit and an activity recognition technique for recognizing content of an image group in units of image groups each including a plurality of images. Recognition processing by the scene recognition technique is an example of “first recognition processing” in the present disclosure. Recognition processing by the activity recognition technique is an example of “second recognition processing” in the present disclosure.

The activity recognition technique is a technique that recognizes images, for example, as an arrangement of a significant image group, such as an image group of “cycling”, an image group of “graduation ceremony”, or an image group of “trip to Hokkaido”, and gives a category label to the image group. The category label is a label indicating semantic labeling to the arrangement of the image group, and is a label of a classification category indicating content, such as an event or an activity corresponding to the content of the image group. The category label may be rephrased as an event label or an activity label. In processing of activity recognition, data of an image and date-of-imaging information associated with the image are used.

The image management server 12 classifies an image group according to the image content based on a result of image analysis by the image processing server 14 and performs grouping for dividing the image group into groups of event categories according to the content of the image group. The description of “event category” includes a concept of a category of an activity. The image groups that are given the same classification information are grouped into a category of the common classification information.

The image management server 12 performs grouping using the category label and the date-of-imaging information. Grouping described herein is processing of creating groups of an image group having an arrangement along specific imaging content (event, activity, theme, or the like).

The recommendation server 16 executes processing of deciding a recommended photo product item (recommended product item) in a group unit (in an image group unit) of the grouped image group, processing of automatically selecting images for use in a photo product item from the group, and processing of deciding a layout of the automatically selected images, and provides the recommendation information regarding the recommended product item to the user terminal 50. A recommendation logic regarding creation of a composite image of the recommended product item, which includes the selection of the images for use in creating the photo product item from the grouped image group and the decision of the layout, and the provision of the recommendation information is controlled using date-of-access information of the user terminal 50 to the system. The access to the system may be, for example, update of an image, login/logout, or update of a folder. A date of update of an image, a date of login, a date of logout, a date of update of a folder, or the like is an example of the date of access of the user terminal 50. Note that the date-of-access information is not limited to the date of access, and may be information regarding a month of access, a year of access, or an access time.

The order reception server 18 receives an order for various print-related products from the user by way of the network 30 and performs order reception processing and settlement processing online. The order reception server 18 creates a composite image for use in each recommended product item based on a kind of the recommended product item decided by group by the recommendation server 16, the automatically selected images, and the layout information. That is, the order reception server 18 creates a sample image of the recommended product item based on information from the recommendation server 16. The order reception server 18 comprises a storage 28, and stores, in the storage 28, a composite image that is a sample image of the recommended product item created by group. The composite image created by the order reception server 18 can be displayed on the user terminal 50 through the recommendation server 16 and the image management server 12. Note that data of the composite image may be stored in the storage 22 of the image management server 12.

The user can determine a need to purchase the photo product item by confirming content of the composite image on a screen of the user terminal 50. Furthermore, the user can edit the composite image by operating the user terminal 50. For example, the user can perform edition, such as replacement of some of a plurality of images automatically selected by the recommendation server 16 with other images.

Note that processing functions of the order reception server 18 may be realized using a plurality of servers. For example, a server that executes the image processing of creating the composite image of the photo product item, a server that executes the order reception processing, and a server that executes the settlement processing may be configured as separate servers.

In FIG. 1, although an example where the processing functions of the image processing system 10 are realized by sharing the processing using the four servers of the image management server 12, the image processing server 14, the recommendation server 16, and the order reception server 18 has been described, a configuration for realizing the processing functions of the image processing system 10 is not limited to this example. For example, the processing functions of the image processing system 10 may be realized by a single server or may be realized by a plurality of servers that are a suitable number of servers of two or more servers.

The image management server 12 is an example of a “first server” in the present disclosure. The storage 22 is an example of a “first storage” in the present disclosure. The image processing server 14 is an example of a “second server” in the present disclosure. The recommendation server 16 is an example of a “third server” in the present disclosure. The order reception server 18 is an example of a “fourth server” in the present disclosure. The storage 28 is an example of a “second storage” in the present disclosure.

Outline of Operation of Image Processing System 10

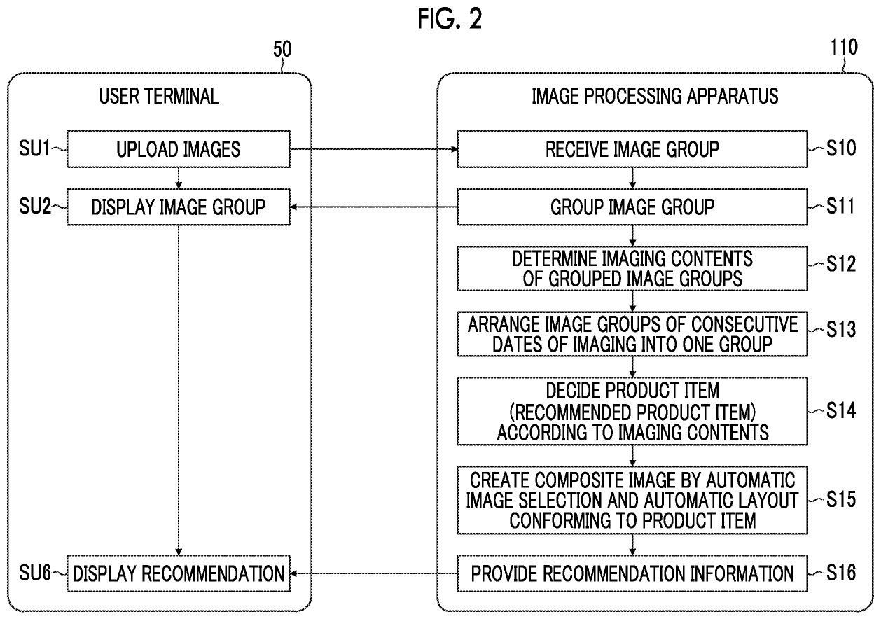

FIG. 2 is a flowchart showing the outline of the operation of the image processing system 10. In FIG. 2, description will be provided assuming that the whole of the image processing system 10 is one image processing apparatus 110. Steps of processing to be executed by the image processing apparatus 110 are realized by at least one processor included in the image processing apparatus 110 executing a command of a program stored in the memory. Furthermore, steps of processing to be executed by the user terminal 50 are realized by one or more processors included in the user terminal 50 executing the command of the program stored in the memory.

The user terminal 50 uploads images to the image processing apparatus 110 through the network 30 (Step SU1). The image processing apparatus 110 receives an image group uploaded from the user terminal 50 (Step S10), and performs grouping of the received image group (Step S11). The image group received by the image processing apparatus 110 in Step S10 is an example of a first image group “in the present disclosure”. The image processing apparatus 110 creates an album on a daily basis from date-and-time-of-imaging information (date-of-image-acquisition information) associated with each image and determines whether or not the image group is important based on the number of captured images per day and an imaging interval. For example, a date of imaging on which the number of captured images is large is determined to be important. Furthermore, in a case where there are a plurality of arrangements of the imaging interval all day, determination is made that the image group is important. Even though the number of captured images is large, in a case where there are many similar images in a short period, determination may be made that re-imaging or continuous shooting is performed, and determination may be made that importance is low. With reception of a result of grouping in Step S11, an album of an image group arranged by date is displayed on the display of the user terminal 50 (Step SU2). Note that, although an example where the image processing apparatus 110 creates a folder on a daily basis has been exemplified, the present disclosure is not limited thereto, and a folder may be created on a monthly basis or on a yearly basis.

The image processing apparatus 110 determines imaging content of the image groups based on image analysis of the image groups grouped in Step S11 (Step S12). The “imaging content” described herein is an event that is common to image content of a plurality of images in the image group, and can include, for example, categories, such as trip, athletic meet, graduation ceremony, and wedding. The determination of the imaging content is performed using the activity recognition technique.

The image processing apparatus 110 may give a label of a common event to all image groups grouped by date or in a case where an image group of a plurality of events is included in the image groups grouped by date, the image group may be grouped into groups by event and a label may be given to each group.

Next, the image processing apparatus 110 executes processing of arranging image groups of the same event of consecutive dates of imaging into one group (Step S13). For example, the image processing apparatus 110 executes processing of arranging of image groups of a trip for a plurality of days into one group.

The image groups grouped by category in Step S12 and the image groups grouped in Step S13 are an example of a “second image group” in the present disclosure.

Next, the image processing apparatus 110 decides an optimum photo product item (recommended product item) according to imaging content of each group (Step S14). In deciding the recommended product item, a validity period regarding recommendation and the content (imaging content) of the image group are taken into consideration. Details of a recommendation logic of the image processing apparatus 110 will be described. The image processing apparatus 110 creates a composite image by automatic image selection and automatic layout conforming to the decided product item (Step S15). In regard to the technique for creating the composite image by automatic image selection and automatic layout, the techniques described in JP2014-007577A, JP2016-167299A, and the like may be applied. The composite image created in Step S15 is an example of a “candidate image” in the present disclosure. Then, the image processing apparatus 110 provides recommendation information regarding the photo product item corresponding to the created composite image to the user terminal 50 (Step S16).

Recommendation display is performed on the display of the user terminal 50 that receives the recommendation information from the image processing apparatus 110 (Step SU6). Steps S10 to S16 of the image processing apparatus 110 shown in FIG. 2 are an example of an image processing method that is executed by the processor of the image processing apparatus 110.

Example of Display Screen in User Terminal 50

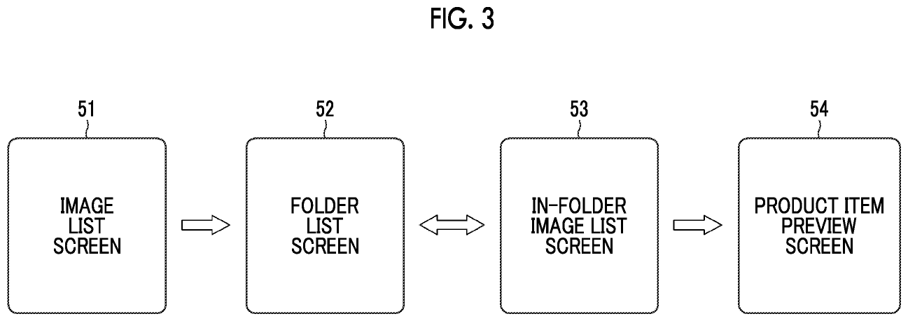

FIG. 3 is a diagram conceptually showing an example of screen transition on a display screen of the display of the user terminal 50. An image list screen 51 is displayed on the display of the user terminal 50 to which the image group is uploaded. The user terminal 50 transits from the image list screen 51 to a folder list screen 52, an in-folder image list screen 53, a product item preview screen 54, or the like according to a user's operation.

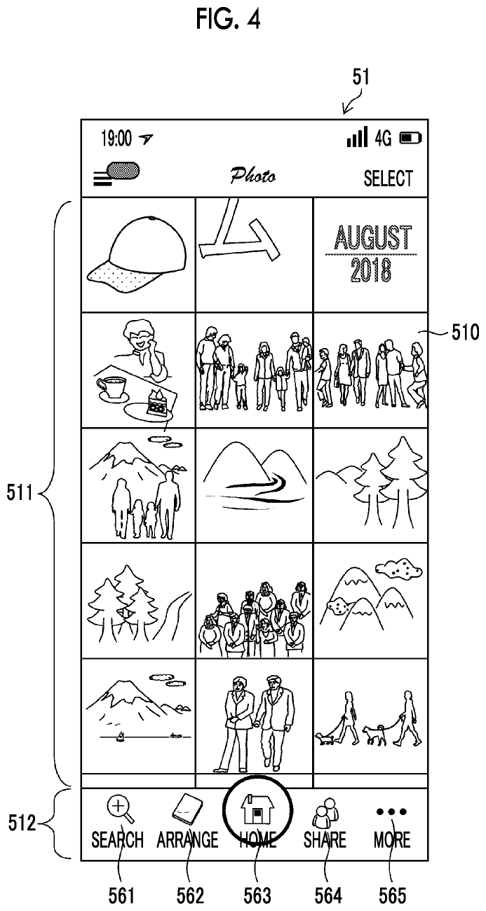

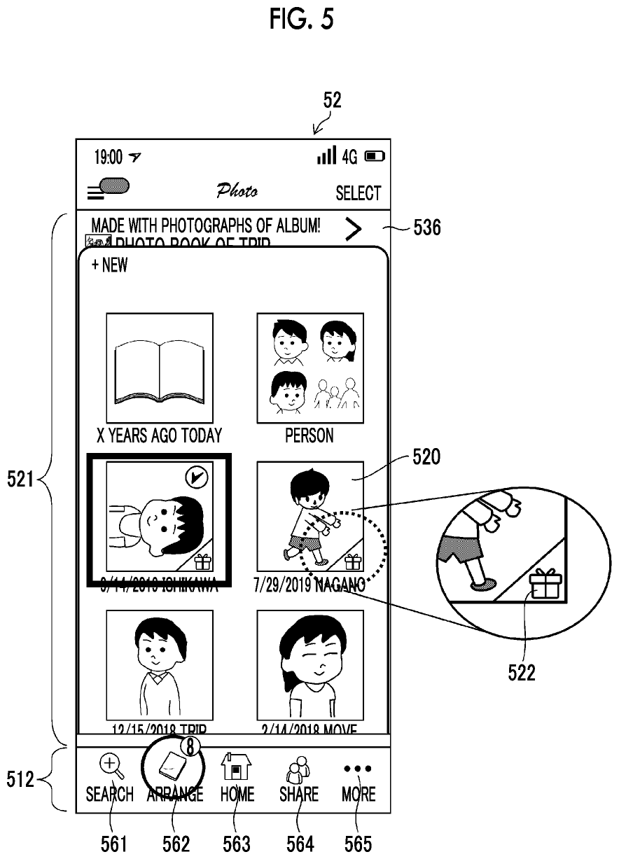

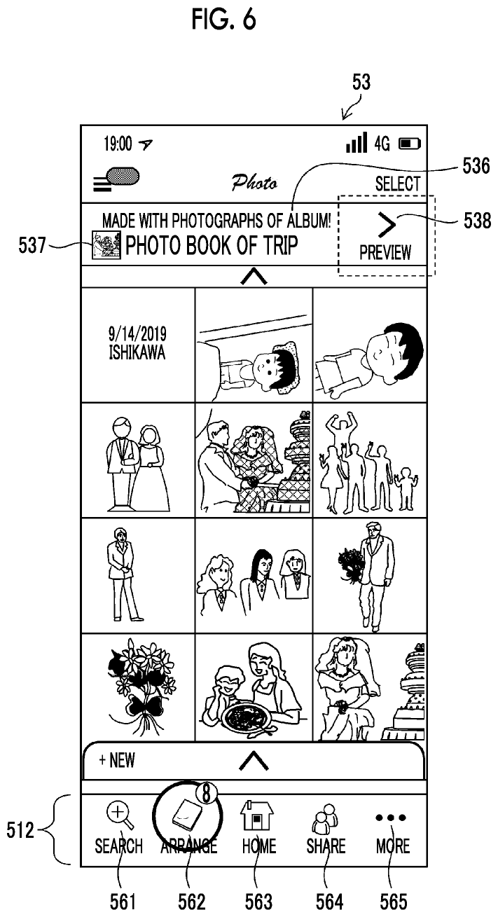

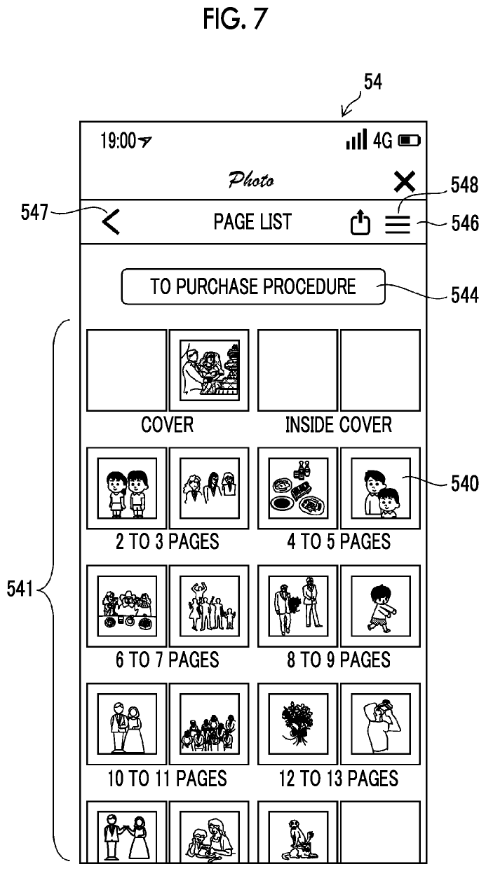

FIG. 4 is an example of the image list screen 51. FIG. 5 is an example of the folder list screen 52. FIG. 6 is an example of the in-folder image list screen 53. FIG. 7 is an example of the product item preview screen 54. Here, a smartphone is exemplified as the user terminal 50.

As shown in FIG. 4, the image list screen 51 includes an image display area 511 and a tool bar 512. In the image display area 511, images 510 uploaded to the storage 22 of the image management server 12 are displayed in a list. In the image display area 511, not only an image group pertaining to the latest upload but also images uploaded in the past, that is, images stored in the storage 22 can be displayed.

In the tool bar 512, a search button 561, a folder display button 562, a home button 563, a share button 564, and an others button 565 are included. The image list screen 51 is displayed when the home button 563 is depressed. Note that the “button” is a graphical user interface (GUI) button. The expression “depress” on the GUI button includes an operation to perform an input or selection of a command corresponding to the button, such as a click or a touch. In a case where the folder display button 562 is depressed, transition is made to the folder list screen 52 shown in FIG. 5.

The folder list screen 52 includes a folder display area 521 and the tool bar 512. In the folder display area 521, a plurality of folders 520 in each of which an image group is grouped are displayed in a list. For each folder 520, for example, a representative image representing images in the folder is displayed as an icon. For the representative image, a combined image in which a plurality of images included in the folder are combined may be displayed as an icon. In an album (folder) where a recommended photo product item (recommended product item) is decided, display indicating that the recommended photo product item is decided may be performed in an area close to the folder. For example, on a lower right side of an icon of an album (folder) where a recommended photo product item is decided, a notice mark 522 informing that there is a suggestion of the recommended photo product item is attached.

In a case where the user selects a desired folder 520 from the folder list screen 52, transition is made to the in-folder image list screen 53 shown in FIG. 6.

The in-folder image list screen 53 includes an in-folder image display area 532 and a recommendation display area 536. In the in-folder image display area 532, image groups in a folder pertaining to selection are displayed in a list. In the recommendation display area 536, recommendation information regarding a recommended photo product item (recommended product item) is displayed. The recommendation display area 536 is disposed in an upper portion of the in-folder image display area 532. In the recommendation display area 536, a recommendation banner including a message informing the user that a sample of a recommended photo product item is created, a composite image 537 for use in a cover of the recommended product item, and a preview button 538 is displayed.

Note that, in a case where there is no recommended photo product item for the image groups of the folder displayed in the in-folder image display area 532, the recommendation banner is brought into non-display. In a case where the preview button 538 is depressed, transition is made to the product item preview screen 54 shown in FIG. 7.

The product item preview screen 54 includes a product item use image display area 541, a purchase procedure button 544, and a tool bar 546. In the product item use image display area 541, automatically selected images 540 and layout information are displayed. In FIG. 7, preview display in a case where a photo book is recommended as an example of a photo product item is shown.

The user confirms the content of the recommended product item on the product item preview screen 54, and in a case where the user desires to purchase the previewed product item, depresses the purchase procedure button 544. On the other hand, in a case where the user does not desire to purchase the product item, the user depresses a return button 547 of the tool bar 546. In a case where the return button 547 is depressed, the in-folder image list screen 53 of FIG. 6 is returned.

Note that, on the product item preview screen 54 of FIG. 7, the user can perform an edition operation, such as replacing some of the previewed images with other images, changing the layout, or changing a title of an album. For example, in a case where a menu button 548 of the tool bar 546 is depressed, an edit button (not shown) is displayed, and in a case where the edit button is depressed, the display screen of the user terminal 50 transits to an edition screen on which an edition operation is received.

Outline of Recommendation

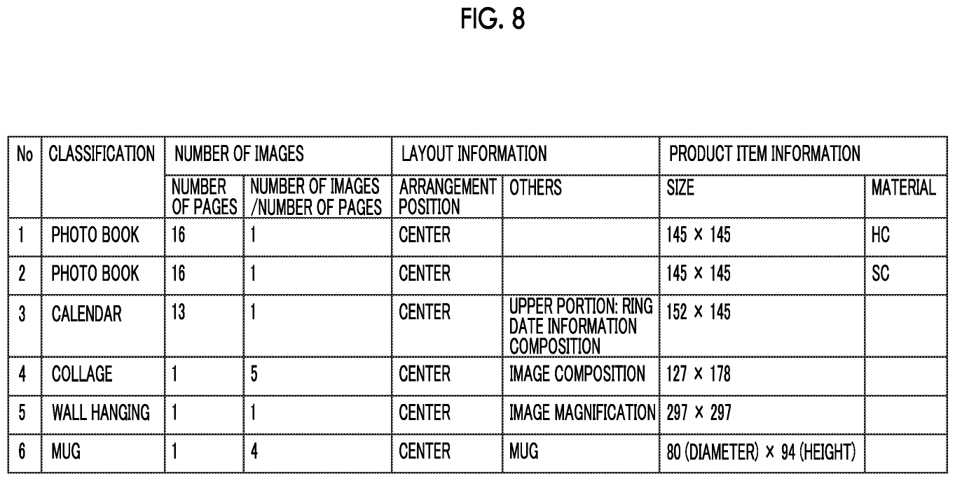

The outline of recommendation that is performed by the image processing apparatus 110 will be described in connection with a specific example. FIG. 8 is a chart exemplarily showing a kind of a photo product item to be a target of recommendation. Here, a photo book, a calendar, a collage, a wall hanging, and a mug are exemplified. The photo book has a plurality of types. A photo book shown in “No. 1” of FIG. 8 is a hardcover (HC) photo book in a square shape with one side of 145 mm A photo book shown in “No. 2” is a softcover (SC) photo book in a square shape with one side of 145 mm.

A calendar shown in “No. 3” is a ring bookbinding type desk calendar and is a calendar in a shape having a size of 152 mm×145 mm A collage shown in “No. 4” is a printed matter obtained by arranging a plurality of images in a template and performing image composition, and is called a design collage print. Note that, in the embodiment, although a photo book, a calendar, a collage, a wall hanging, and a mug are exemplified as the photo product item, the present disclosure is not limited thereto. For example, a photo product item in which a photograph is printed on a commodity, for example, clothing, such as a T-shirt, stationery, or cup. A plurality of product items that are different in size, material, and shape may be stored as candidate product items of a recommended product item for a kind of one product item.

The detailed specification of each product item can be suitably designed. In the embodiment, a product item is stored corresponding to number-of-images information and layout information. The number-of-images information includes, for example, information indicated by the number of pages and the number of images of each page. The layout information includes, for example, disposition position information of the images on the page, mount information for arranging the images, and title information. For example, the specification of the photo book can be determined that the number of pages is 16 pages, one image is disposed on one page, the number of images is 15 images in total including one image on a cover and 14 images on intermediate pages, a layout pattern has a square image disposed at the center of one page, a background mount is white, a title representing event content of an image group of an album is attached to a spine cover as a title, and the like. For example, the specification of the calendar can be determined that the number of pages is 13 pages, one image is disposed on one page, the number of images is 13 images in total including one image on a cover and 12 images on intermediate pages, a layout pattern is a calendar composite image in which an image and a calendar by month are composed according to a pattern of a calendar mount, no title is attached, the calendar starts from January or April in such a manner that the month of start is January in a case where a recommendation time is January and is April in a case where a recommendation time is April, and the like. Note that, in FIG. 8, although three kinds of product items are exemplified, actually, more kinds of product items may be prepared.

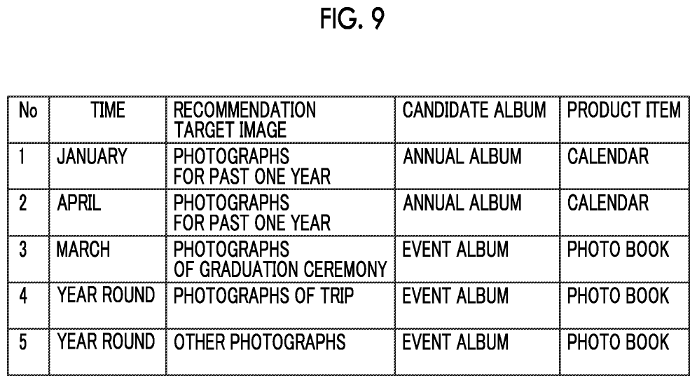

FIG. 9 is a chart in which a relationship between a condition of recommendation and a product item to be recommended is arranged. As shown in FIG. 9, a plurality of kinds of product items are prepared as a product item to be a target of recommendation, and a recommendation condition is set for each product item.

Recommendation content is decided according to a time at which the user uploads images and content of a grouped album. For example, in a case where upload of images is performed in January, recommendation of a calendar created using images in an annual album including photographs over the last year is performed. In a case where the time of upload is January, a calendar that starts from January is suggested. Similarly, in a case where upload of images is performed in April, recommendation of a calendar created using images in an annual album including photographs over the last year is performed. In a case where the time of upload is April, a calendar that starts from April is suggested.

In a case where upload of images is performed in March, and content of an album is an event album of “graduation ceremony”, recommendation of a photo book is performed. In a case where a condition regarding a time is set to “year round”, for example, recommendation of a photo book may be performed for an event album, such as “trip”, regardless of the time.

In the image processing apparatus 110 according to the embodiment, as the setting of the condition regarding the time of recommendation, two kinds of validity periods of a logic validity period and a recommendation display validity period are set. The logic validity period is a period during which execution of processing (hereinafter, referred to as recommendation logic processing) of creating a composite image (candidate image) of a photo product item to be recommended on a target album is permitted. The recommendation logic processing is executable only within the logic validity period, and data of a recommendation preview (recommendation information) including the composite image created by executing the recommendation logic processing is stored in the storage 28.

The recommendation display validity period is a period during which display of the recommendation information based on a result of the recommendation logic processing executed within the logic validity period on the user terminal 50 is permitted. That is, the recommendation display validity period determines a period during which the recommendation information is provided to the user. The recommendation display validity period can be set to be equal to the logic validity period, and an end date of the recommendation display validity period can be set to a date later than an end date of the logic validity period. The recommendation display validity period may be set as a given period after recommendation preview creation (for example, over two weeks after recommendation preview creation).

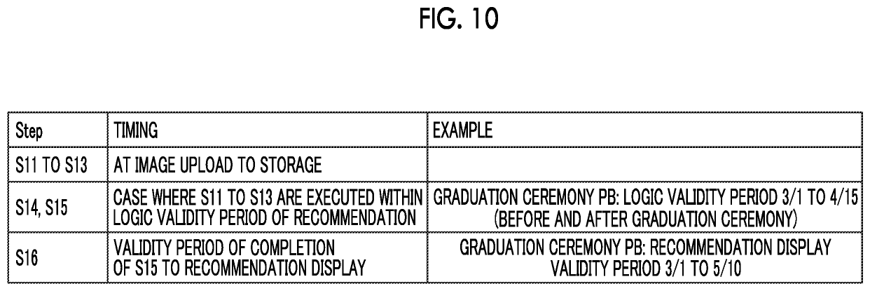

FIG. 10 is a chart showing an example of an execution timing of processing by the image processing apparatus 110. Step numbers, such as S11 in the drawing correspond to the step numbers of the processing described referring to FIG. 2.

Processing of Steps S11 to S13 is executed when image upload from the user terminal 50 to the storage 22 is performed. In a case where Steps S11 to S13 are executed, the image list screen 51 or the folder list screen 52 is displayed on the display screen of the user terminal 50.

Processing of Steps S14 and S15 is executed in a case where Steps S11 to S13 are executed in the logic validity period of recommendation. For example, a logic validity period in a case where a photo book (PB) of a graduation ceremony is recommended is set to a period of March 1 to April 15. It is considered that the logic validity period regarding the photo book of the graduation ceremony is set to a period including a time before and after the graduation ceremony from a viewpoint of effectiveness.

Processing of Step S16 is executed within a duration of a recommendation display validity period from completion of Step S15. For example, a recommendation display validity period of the photo book (PB) of the graduation ceremony is set to a period of March 1 to May 10. Even after the logic validity period ends, in a case where the recommendation logic processing is already executed within the logic validity period, and data of a composite image or the like of a processing result is stored in the storage 28, recommendation display is performed using data stored in the storage 28.

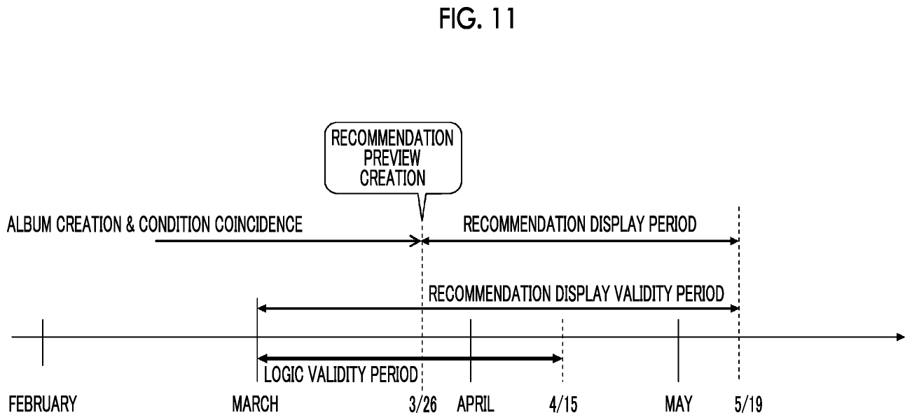

FIG. 11 is a diagram schematically showing a setting example of a logic validity period and a recommendation display validity period. FIG. 11 shows an example of a case where a photo book of a graduation ceremony is recommended. In regard to the photo book of the graduation ceremony, the logic validity period is set to, for example, a period of March 1 to April 15, and the recommendation display validity period is set to, for example, a period of March 1 to May 10. Furthermore, FIG. 11 shows an example of a recommendation display period during which recommendation display is actually performed in the user terminal 50.

In a case where an album is created on an uploaded image group, and a recommendation condition including a condition of a logic validity period on the album is consistent, recommendation logic processing is executed to create a recommendation preview, and recommendation information is displayed on the user terminal 50. FIG. 11 shows an example of a case where an image group regarding an event of “graduation ceremony” is included among image groups uploaded on March 26, and an album of a graduation ceremony is created.

In this case, since the date of upload of the image group is the logic validity period during which the photo book of the graduation ceremony is recommended, the recommendation logic processing is executed, and the recommendation preview of the photo book of the graduation ceremony as a recommended product item is created. Information regarding the recommendation preview created in this case is stored in the storage 28 and is stored until the recommendation display validity period is expired. Accordingly, in a case where the user terminal 50 accesses the image processing apparatus 110 within the recommendation display validity period, the recommendation information of the target album is displayed in the user terminal 50. In a case where the recommendation display validity period has elapsed, the recommendation display is turned off. Note that, after the recommendation display validity period is expired, information regarding the recommendation preview may be deleted from the storage 28.

Classifications of Calendar Event and Normal Event

An event for which a time is already limited on a calendar, such as “graduation ceremony” or “summer vacation” is referred to as a “calendar event”, and an event for which various times are supposed throughout the year and there is no particular limitation to the time, such as “trip”, is referred to as a “normal event”. The logic validity period is set for an album of a calendar event.

On the other hand, the recommendation logic processing is validated throughout the year for an album of a normal event.

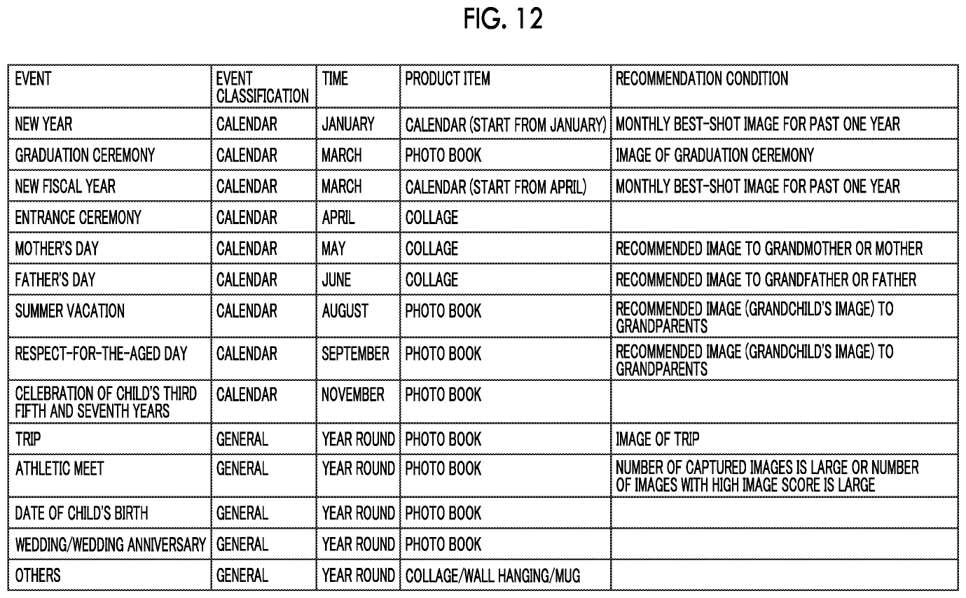

FIG. 12 is a chart showing an example of a product item to be recommended according to a classification of an event. “Event classification” in FIG. 12 is a classification indicating whether an event is an event having a particular limitation to the time by the provision on the calendar or a normal (any time) event. “Time” indicates a rough time that is set as the logic validity period. For example, “January” means that a period from January 1 to January 31 is set as the logic validity period. “Year round” described in the column “time” means that it is valid throughout the year. “Collage” described in a column “product item” indicates a design collage print. “Wall hanging” indicates a photograph panel that is subjected to panel working (framing) for wall decoration.

Setting of Push Notification of Recommendation

The image processing apparatus 110 is configured to set execution (push notification on) or non-execution (push notification off) of push notification according to content to be recommended. For example, recommendation of a product item related to an important event, such as calendar event, is set to “push notification on” such that the push notification is performed. On the other hand, recommendation of a product item related to other normal events is set to “push notification off” such that the push notification is turned off.

In regard to a recommended product item, while it is desirable that as many kinds as possible are created according to content of an album, there is a concern that, in a case where notification of recommendation is too frequently performed, the user feels troublesome. For this reason, it is desirable for a configuration in which the on/off of the push notification can be defined such that the push notification is performed only for a specific product item, such as a notice of a recommended product item for an album of a calendar event.

Specific Example of Product Item Recommendation Logic Specification

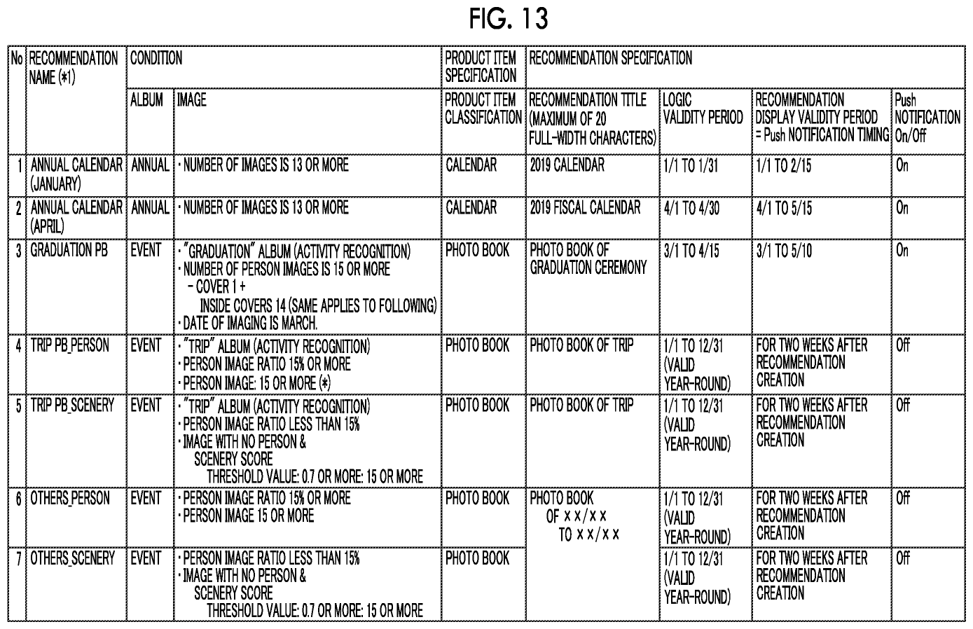

FIG. 13 is a chart showing a specific example of a product item recommendation logic specification that is applied to the image processing apparatus 110. As shown in FIG. 13, as the recommendation specification, the logic validity period, the recommendation display validity period, and the on and off of the push notification are set for each product item to be recommended. In a case of push notification on, a validity period of the push notification may be the same as the recommendation display validity period.

In deciding an optimum product item for a grouped album, the logic validity period and imaging content are taken into consideration. For example, a product item for a graduation ceremony, such as a photo book of “graduation ceremony”, is stored corresponding to graduation that is a category label as the imaging content of the album and a logic validity period indicating March as a graduation season corresponding to the graduation as a category label.

The recommendation logic processing may be executed taking into consideration not only the category label but also the number of images included in the album, a ratio of a person or a scenery image, or an evaluation value of an image with respect to the imaging content of the album. For example, in a case where there are a given number of images or more grouped into a category of a graduation ceremony, a photo book of “graduation ceremony” is decided, and in a case where there are a given number of images or more grouped into a category of a trip, a photo book of “trip” is decided. Furthermore, the recommendation logic may be given priority. For example, a No. column indicates priority, and in a case where No. 4 and No. 6 are simultaneously satisfied in a folder with a category label of “trip”, the recommendation logic of No. 4 may be executed with priority. Note that priority may be set for respective image content (category label) of a folder in advance.

With respect to the processing of the automatic image selection and the layout according to the product item, for example, in a case of a calendar, processing of extracting a best shot on a monthly basis and disposing the best shot on each page is executed. Note that the extraction of the best shot is performed using an image score as an image evaluation value attached to each image based on image analysis.

Operation of Image Processing System 10

The image processing system 10 substantially executes the following processing.

[Step 1] Receipt of image group.

[Step 2] Image analysis and folder (album) creation.

[Step 3] Determination on whether or not it is within logic validity period.

[Step 4] In a case where it is the logic validity period, the recommendation logic processing is executed. In a case where it is not the logic validity period, the recommendation logic processing is brought into non-execution.

[Step 5] In a case where it is the recommendation display validity period, determination is made whether or not there is a composite image (recommendation preview), and in a case where there is the composite image, the composite image is displayed.

[Step 6] In a case where a button of the recommendation banner is depressed, transition is made to the order reception server.

Hereinafter, each step of Step 1 to Step 6 will be further described in detail.

Description of [Step 1]

The step in which the receipt of the image group is performed corresponds to Step S10 described referring to FIG. 2, and corresponds to image list screen 51 as the display screen in the user terminal 50.

The image management server 12 receives the image group uploaded from the user terminal 50 and updates the image group stored in the storage 22. A timing of update may be set, for example, by automatic processing according to activation of an application by the user or based on a user's operation. Alternatively, automatic update under the application activation of the user terminal 50 and a Wi-Fi connection environment may be performed or automatic update under the application activation and a mobile communication environment may be performed.

The image management server 12 acquires data indicating a date of receipt of the image group (date of receipt of images) and data of the uploaded images. Note that the date of receipt of images may be rephrased as a date of reception of images. The image management server 12 acquires data of a date of update or a date of login as data indicating the date of receipt of images. Information regarding the date of receipt of images of the image group is an example of “date-of-acquisition information of a first image group” in the present disclosure. Information regarding the date of receipt of images is associated with user identification information (user ID) and is updated to a latest date. Otherwise, data of the date of receipt of images is sequentially recorded in an update order and is accumulated as a history. Furthermore, date information of a date on which each image is acquired (generated) is associated with each image. A date of image acquisition of an image captured using a smartphone, a digital camera, or the like is typically a date of imaging A date of image acquisition of an image digitized using a scanner is a date on which a digital image is generated by the scanner. Hereinafter, a case where date-of-imaging information is given as an example of the date-of-image-acquisition information of each image is exemplified.

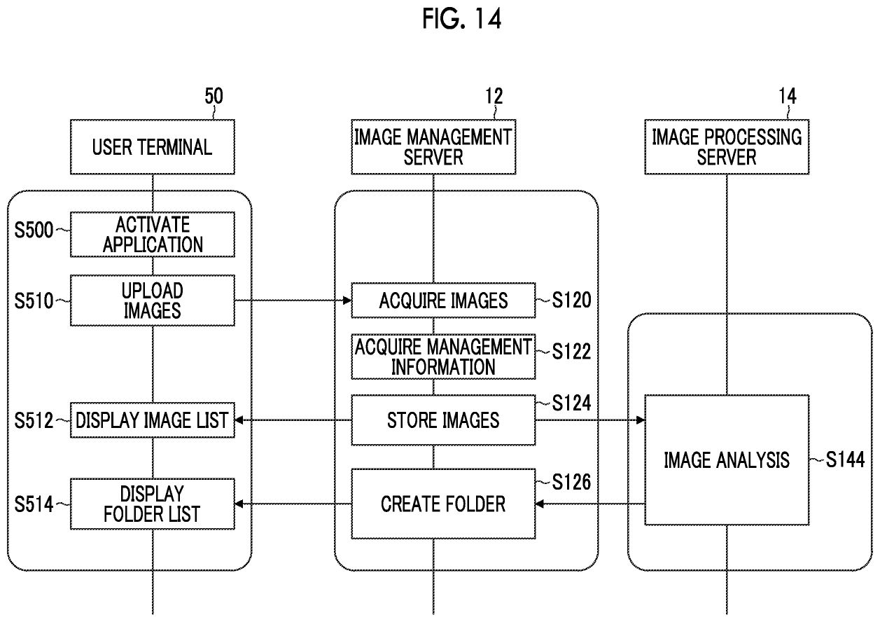

FIG. 14 is a flowchart exemplarily showing a receipt operation of an image group by the image management server 12 and operations of image analysis by the image processing server 14 and folder creation by the image management server 12. FIG. 14 shows a relationship of the user terminal 50, the image management server 12, and the image processing server 14.

In a case where the application of the user terminal 50 is activated (Step S500), and login is made to the image processing system 10, upload of an image group is performed from the user terminal 50 (Step S510). The image management server 12 acquires the image group uploaded from the user terminal 50 (Step S120), and acquires management information (Step S122). The image management server 12 acquires, as the management information, information regarding the date of update or the date of login and the date-of-imaging information of each image. The image management server 12 stores the acquired image group in the storage 22 (Step S124). In a case where data of the storage 22 is updated, the image groups are displayed in a list in an order of the date of imaging in the user terminal 50 (Step S512). A display example in Step S512 is the image list screen 51 described referring to FIG. 4. Note that the activation of the application of the user terminal 50 may be downloading a dedicated application regarding the image processing system 10 and activating the application, and also includes activating a browser application of the user terminal 50 and accessing a login page from a specific URL. Note that, in Step S512, although the image groups are displayed in a list in an order of the date of imaging, the present disclosure is not limited thereto, and the image groups may be displayed in a list in an order of the date of update.

Description of [Step 2]

The step in which the image analysis and the folder (album) creation are performed corresponds to Steps S11 to S13 described referring to FIG. 2, and corresponds to the folder list screen 52 and the in-folder image list screen 53 as the display screen in the user terminal 50.

The image management server 12 creates folders based on the date-of-imaging information (date-of-image-acquisition information) of the images. For example, the image processing server 14 performs image analysis for each folder and gives classification information (label) to the folder according to a classification condition.

Otherwise, the image management server 12 creates folders based on the date-of-imaging information of the images. Then, the image processing server 14 performs image analysis for each image and gives classification information according to the content of the image. The image management server 12 gives classification information to the folder according to a proportion of the images given the classification information. Note that the image processing server 14 may perform image analysis for each image and may give classification information according to the content of the image, and the image management server 12 may create a folder for each image given the classification information.

Alternatively, the following form may be made. That is, the image management server 12 creates temporary folders based on the date of image acquisition. The image processing server 14 performs image analysis for each image and gives classification information to a first temporary folder according to the content of the image.

The image processing server 14 maintains the first temporary folder as it is in a case where the first temporary folder is a first classification. The image processing server 14 gives classification information to a second temporary folder continuous to the first temporary folder by date.

The image processing server 14 compares the classification information of the first temporary folder with the classification information of the second temporary folder, and gives the classification information to the first temporary folder as a regular folder in a case where both classifications are different. On the other hand, in a case where the classifications are identical, the classification information of the second temporary folder is compared with classification information of a third temporary folder continuous to the second temporary folder by date. In a case where the classification information of the second temporary folder and the classification information of the third temporary folder are different, the first temporary folder and the second temporary folder are combined and given classification information as one regular folder. In this way, a folder having a photograph group (second photograph group) related to a plurality of dates may be generated. The image processing server 14 brings a temporary folder into non-display as display, and displays only a regular folder.

Data associated with a folder includes a regular folder flag, a temporary folder flag, classification information, and the like.

Data related to the classification condition includes the classification information indicating a classification label, the date of imaging, the number of images, the person or scenery image ratio, the image evaluation value (image score) equal to or greater than a threshold value, the image content, priority, and the like.

As shown in FIG. 14, the image processing server 14 acquires an image group from the image management server 12 and performs image analysis (Step S144). The image processing server 14 discriminates imaging content of each image and gives classification information, such as an event label. The image processing server 14 acquires an image score or the like indicating the image evaluation value of each image. An image analysis result of the image processing server 14 is sent to the image management server 12.

The image management server 12 creates folders by date of imaging based on the image analysis result (Step S126). Information regarding the folders created in the image management server 12 is sent to the user terminal 50, and a folder list is displayed in the user terminal 50 (Step S514).

Description of [Step 3]

The step in which determination is made whether or not it is within the logic validity period corresponds to Step S14 described referring to FIG. 2.

The recommendation server 16 compares the date-of-acquisition information of the first image group with the logic validity period to determine whether or not it is within the logic validity period.

Otherwise, the recommendation server 16 may compare the date-of-acquisition information of the first image group with the logic validity period and may further determine whether or not it is suitable for a logic condition.

Alternatively, the recommendation server 16 compares the date-of-acquisition information of the first image group with the logic validity period, and determines logic priority in a case where the date-of-acquisition information of the first image group conform to a plurality of logic validity period.

The date-of-acquisition information of the first image group may be date-of-upload information on which an image is uploaded from the user terminal 50. Data regarding the recommendation logic include the logic condition, the product item specification (logic content), the logic validity period, logic priority, and the like.

Logic priority may be set, from example, from the viewpoint of the number of pages of the product item, the length of the logic validity period, the degree of popularity of the product item, or the like.

Data regarding the logic condition includes a user attribute, folder classification information of an image, the number of images, the person image ratio, the date of imaging, an excluded image condition, and the like.

Data regarding the product item specification includes the number of pages, the layout information, the title, and the like.

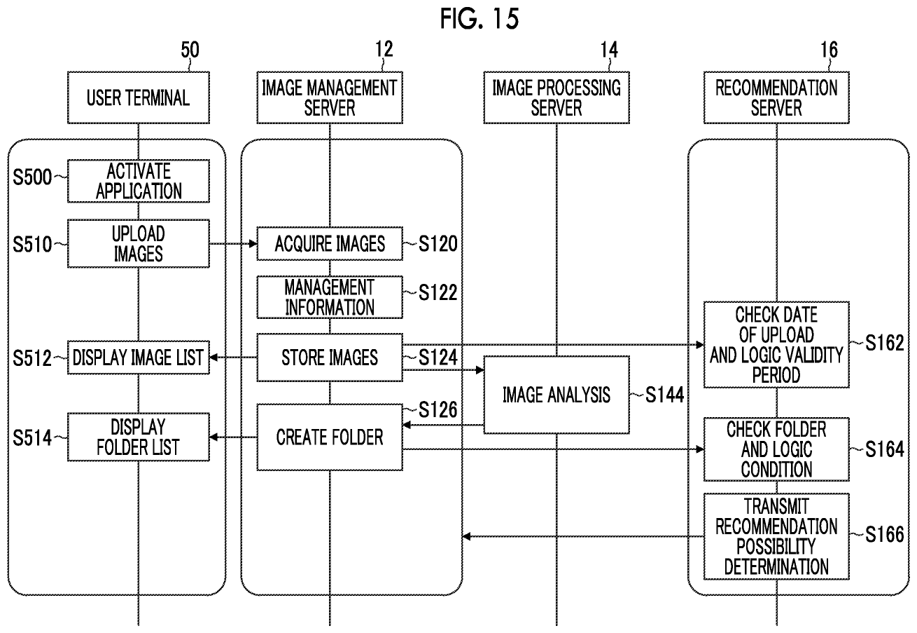

FIG. 15 is a flowchart exemplarily showing the operation of the determination on whether or not it is within the logic validity period in the recommendation server 16. FIG. 15 shows a relationship of the user terminal 50, the image management server 12, the image processing server 14, and the recommendation server 16. In FIG. 15, the steps common to FIG. 14 are represented by the same step numbers, and description thereof will not be repeated.

The recommendation server 16 acquires information regarding the date of upload through the image management server 12 and checks the date of upload and the logic validity period (Step S162). In addition, the recommendation server 16 checks the folders and the logic condition (Step S164). The recommendation server 16 determines permission or inhibition of recommendation for each folder based on determination results of Steps S162 and S164, and transmits a determination result to the image management server 12 (Step S166).

Description of [Step 4]

The step in which the recommendation logic processing is executed in a case where it is the logic validity period, and the recommendation logic processing is brought into non-execution in a case where it is not the logic validity period corresponds to Step S15 described referring to FIG. 2. As the display screen in the user terminal 50, the step corresponds to the recommendation banner shown in the recommendation display area 536 in the upper portion of the in-folder image list screen 53 illustrated in FIG. 6 and the product item preview screen 54 illustrated in FIG. 7.

The recommendation logic processing includes processing of deciding a recommended product item, selecting images from a folder, and deciding a layout. The recommendation server 16 executes the recommendation logic processing. The recommendation server 16 selects the images from the folder, decides the layout, and transmits the selected images and the layout information to the order reception server 18.

The order reception server 18 generates a composite image of the recommended product item based on the recommended product item information, and the images and the layout information received from the recommendation server 16 and stores the generated composite image in the storage 28.

Data for use in the recommendation logic processing includes information regarding the folder, an extraction condition for image selection, a layout condition, and the like. Information regarding the folder includes information regarding the regular folder, the selected images, the layout, the composite image, unselected images, and the like. The unselected images can become images for edition.

The extraction condition of the selected images includes the priority of automatic image selection and information regarding images to be excluded. Priority may be determined by, for example, the image score, the number of times of appearance, a priority tag, or a suitable combination thereof. In regard to the images to be excluded, for example, images of low resolution, similar images, and the like may be determined to be excluded. The layout condition may be determined such that the images are arranged, for example, in time series of the date of imaging.

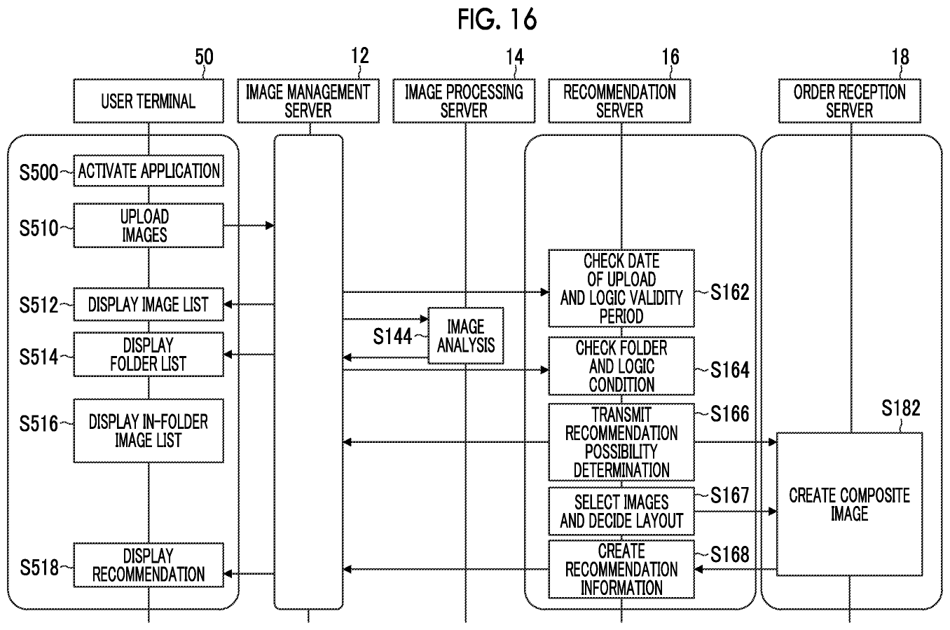

FIG. 16 is a flowchart exemplarily showing an operation regarding the recommendation logic processing and an operation regarding the recommendation display. FIG. 16 shows a relationship of the user terminal 50, the image management server 12, the image processing server 14, the recommendation server 16, and the order reception server. In FIG. 16, the steps common to FIG. 15 are represented by the same step numbers, and description thereof will not be repeated.

The recommendation server 16 selects images for use in a recommended product item on a folder suitable for the logic validity period and the logic condition and decides a layout of the selected images (Step S167). Information regarding the selected images and the layout is sent to the order reception server 18.

The order reception server 18 generates a composite image of the recommended product item based on the selected images and the layout information received from the recommendation server 16 (Step S182). Information regarding the generated composite image is sent to the recommendation server 16, and recommendation information is generated in the recommendation server 16 (Step S168).

The recommendation information is sent from the recommendation server 16 to the user terminal 50 by way of the image management server 12. In the user terminal 50, at the time of display of the images in the folder (Step S516), recommendation display (Step S518) including a composite image 537 of a cover of the recommended product item is performed in the upper portion of the screen (see FIG. 6).

Description of [Step 5]

The step in which, in a case where it is the recommendation display validity period, determination is made whether or not there is a composite image (recommendation preview), and the composite image is displayed in a case where there is the composite image corresponds to Step S16 described referring to FIG. 2.

The composite image generated in the order reception server 18 is stored in the storage 28, and in a case where it is within the recommendation display validity period, the composite image is read from the storage 28 and is provided to the user terminal 50.

For example, in a case where the folder display button 562 is depressed on the image list screen 51 displayed on the user terminal 50, transition is made to the folder list screen 52. In displaying the folder list screen 52, determination on the presence or absence of a regular folder, the presence or absence of a composite image, and the recommendation display validity period is performed in the recommendation server 16.

On a regular folder and a folder satisfying the recommendation display validity period, distinctive display is performed on the user terminal 50 according to the presence or absence of the composite image. The notice mark 522 described referring to FIG. 5 is an example of the distinctive display.

In a case where a folder with the notice mark 522 is selected and is displayed on the in-folder image list screen 53, as in FIG. 6, the composite image 537, the display of the image group, and the preview button 538 linked to a production item preview are displayed.

In a case where a target folder does not satisfy the recommendation display validity period, that is, in a case where there is no recommended product item to be suggested to the user, the recommendation banner in the recommendation display area 536 is brought into non-display.

Description of [Step 6]

In a case where the preview button 538 of the recommendation banner is depressed, a site of the order reception server 18 is directed, and the product item preview screen 54 is displayed on the user terminal 50 (FIG. 7). The preview button 538 may be referred to as a “recommendation button”.

The selected images and the layout information are transmitted from the order reception server 18 to the user terminal 50, and there is a purchase procedure of a product item from the product item preview screen 54 displayed on the user terminal 50.

Furthermore, information regarding the unselected images (images for edition) may be transmitted from the order reception server 18 to the user terminal 50 in addition to the selected images and the layout information, and an edition operation, such as image replacement, may be received on the product item preview screen 54.

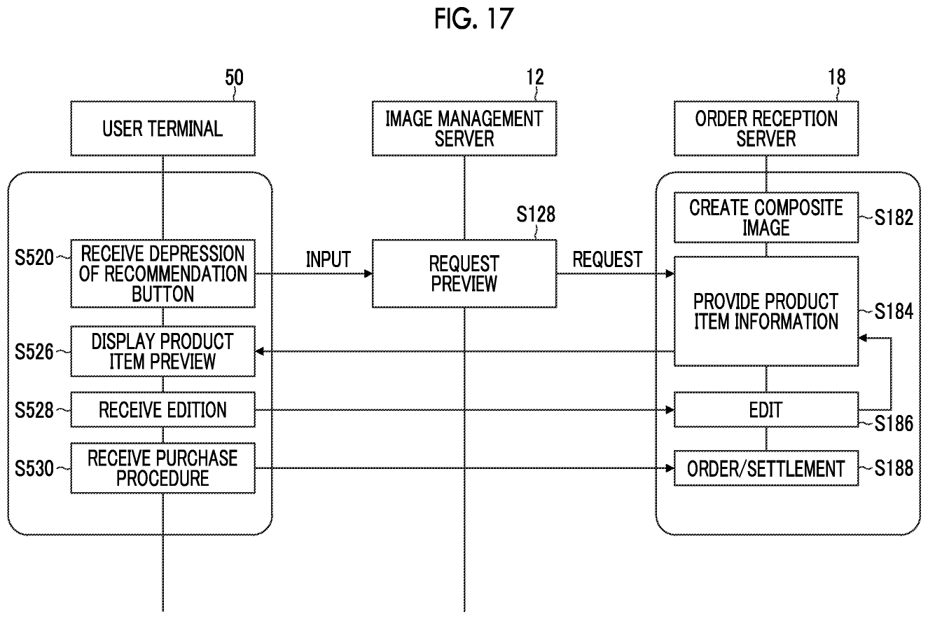

FIG. 17 is a flowchart exemplarily showing an operation regarding the display of the product item preview screen. In the user terminal 50, it is assumed that the recommendation display (Step S518) described referring to FIG. 16 is being performed.

As shown in FIG. 17, the user terminal 50 receives a depression operation of the recommendation button in a state in which the recommendation banner is displayed (Step S520). In a case where the recommendation button of the user terminal 50 is depressed, an input to the recommendation button is performed from the user terminal 50 to the image management server 12, and the image management server 12 transmits a preview request to the order reception server 18 (Step S128).

The order reception server 18 transmits product item information including a composite image of the product item to the user terminal 50 according to the request from the image management server 12 (Step S184).

The user terminal 50 receives the product item information from the order reception server 18 and performs product item preview display (Step S526). The user terminal 50 receives an edition operation from the user (Step S528). In a case where the edition operation is performed, the instruction content of the edition operation is sent to the order reception server 18, and edition processing, such as image replacements, is executed in the order reception server 18 (Step S186). In the user terminal 50, a product item preview after edition is displayed.

Furthermore, the purchase procedure button is displayed on the product item preview screen 54 in the user terminal 50, and a purchase procedure is received (Step S530).

In a case where the purchase procedure button is depressed, transition is made to processing of an order and settlement in the order reception server 18 (Step S188). The order reception server 18 may be rephrased as an order server.

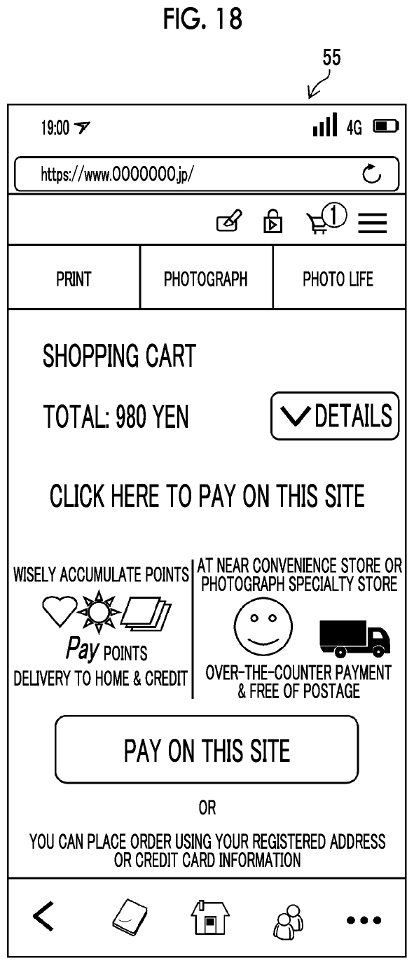

FIG. 18 shows a display example of an order screen. In a case where the purchase procedure button shown in FIG. 7 is depressed, an order screen 55 shown in FIG. 20 is displayed on the user terminal 50. The order screen is also used as a settlement screen, and settlement can be completed online.

Example of Hardware Configuration of Computer

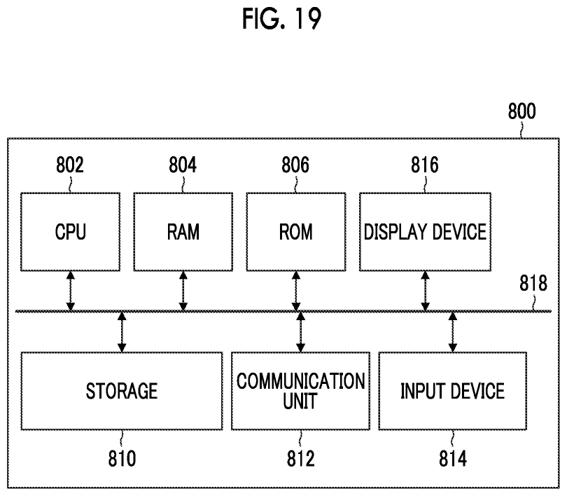

FIG. 19 is a block diagram showing an example of the hardware configuration of a computer. A computer 800 may be a personal computer, may be a workstation, or may be a server computer. The computer 800 can be used as a part or the whole of any one of the user terminal 50, the image processing apparatus 110, the image management server 12, the image processing server 14, and the recommendation server 16, and the order reception server 18 or a device having a plurality of functions thereof.

The computer 800 comprises a central processing unit (CPU) 802, a random access memory (RAM) 804, a read only memory (ROM) 806, a graphics processing unit (GPU) 808, a storage 810, a communication unit 812, an input device 814, a display device 816, and a bus 818.

The CPU 802 reads various programs stored in the ROM 806, the storage 810, or the like and executes various kinds of processing. The RAM 804 is used as a work area of the CPU 802. The RAM 804 is also used as a storage unit that temporarily stores the read programs and various pieces of data.

The storage 810 includes, for example, a storage device constituted using a hard disk device, an optical disc, a magneto-optical disc, a semiconductor memory, or a suitable combination thereof. In the storage 810, various programs, data, and the like are stored. A program stored in the storage 810 is loaded to the RAM 804, and the CPU 802 executes the program, whereby the computer 800 functions as a unit that executes various kinds of processing defined by the program.

The communication unit 812 is an interface that executes communication processing with an external device in a wired or wireless manner and exchanges information with the external device. The communication unit 812 can play a role as an information acquisition unit that receives an input of images and the like.

The input device 814 is an input interface that receives various operation inputs on the computer 800. The input device 814 may be, for example, a keyboard, a mouse, a touch panel, other pointing devices, a sound input device, or a suitable combination thereof.

The display device 816 is an output interface on which various kinds of information are displayed. The display device 816 may be, for example, a liquid crystal display, an organic electro-luminescence (OEL) display, a projector, or a suitable combination thereof.

Program that Operates Computer

A program that causes a computer to realize a part or the whole of at least one processing function among processing functions of the devices, such as the image management server 12, the image processing server 14, the recommendation server 16, the order reception server 18, and the image processing apparatus 110 described in the above-described embodiment can be recorded on an optical disc, a magnetic disc, a semiconductor memory, or a computer-readable medium, which is a tangible non-transitory information storage medium, and can be provided through the information storage medium.

Instead of an aspect in which the program is stored in such a tangible non-transitory computer-readable medium and provided, a program signal may be provided as a download service using an electric telecommunication line, such as the Internet.

Hardware Configuration of Each Processing Unit

A hardware structures of processing units that execute processing of the devices, such as the image management server 12, the image processing server 14, the recommendation server 16, the order reception server 18, and the image processing apparatus 110 described in the embodiment are, for example, various processors described below.

Various processors include a CPU that is a general-purpose processor executes a program to function as various processing units, a GPU that is a processor specialized for image processing, a programmable logic device (PLD) that is a processor capable of changing a circuit configuration after manufacture, such as a field programmable gate array (FPGA), a dedicated electric circuit that is a processor having a circuit configuration dedicatedly designed for executing specific processing, such as an application specific integrated circuit (ASIC), and the like.

One processing unit may be configured of one of various processors described above or may be configured of a combination of two or more processors of the same type or different types. For example, one processing unit may be configured of a plurality of FPGAs, a combination of a CPU and an FPGA, or a combination of a CPU and a GPU. A plurality of processing units may be configured of one processor. As an example where a plurality of processing units are configured of one processor, first, as represented by a computer, such as a client or a server, there is a form in which one processor is configured of a combination of one or more CPUs and software, and the processor functions as a plurality of processing units. Second, as represented by system on chip (SoC) or the like, there is a form in which a processor that realizes all functions of a system including a plurality of processing units into one integrated circuit (IC) chip is used. In this way, various processing units are configured using one or more processors among various processors described above as a hardware structure.

In addition, the hardware structure of various processors is, more specifically, an electric circuit (circuitry), in which circuit elements, such as semiconductor elements, are combined.

Advantage of Image Processing System according to Embodiment

(1) It is possible to suggest, to a person (user) who uses the image storage service, an appropriate product item using stock images of the user at an appropriate timing in conformity with a timing at which the user accesses the image processing system 10.

(2) Appropriate images for a product item are automatically selected from an image group uploaded by the user, and a candidate image of a sample of a recommended product item is created by an automatic layout. Thus, it is possible to allow the user to simply confirm the content of the product item without performing a complicated operation, such as a selection operation of images.

(3) It is possible to achieve a reduction in processing load and effective utilization of resources by restricting the validity period of the operation of the recommendation logic processing, such as creation of a composite image based on image selection for a product item and layout decision.

### Modification Example 1

The kind of a product item as a target of recommendation is not limited to a photo book and a calendar, and may be, for example, a design collage print or a wall hanging. The number of images for use in creating a product item may be one according to the kind of the product item. In this case, a sample image that is created from one selected image is created instead of a “composite image”.

### Modification Example 2

In the above-described embodiment, although the image processing system 10 has been described as an example, an application range of the technique of the present disclosure is not limited to this example. For example, the technique of the present disclosure can also be applied to a social networking service (SNS) system. The SNS system is similar to the image processing system 10 in that posting of images is received from users and images are stored for each user. In the SNS system, it is possible to apply the same recommendation system as the image processing system 10.

### Description of Terms and Other Aspects of the Present Disclosure

The date-of-acquisition information of the first image group is equivalent to information regarding a date (date of receipt) on which the image processing apparatus receives the first image group. The candidate image is equivalent to an image of a product item sample (sample) corresponding to the recommended product item. With the image processing apparatus according to the aspect of the present disclosure, it is possible to perform recommendation suggesting an appropriate recommended product item at an appropriate timing according to the content of the second image group of the groups classified according to the image content from the first image group and the date-of-acquisition information. Note that the date-of-acquisition information of the first image group is not limited to the date of acquisition of the first image group, a month of acquisition of the first image group, a year of acquisition of the first image group, or an acquisition time of the first image group. The candidate image includes, for example, an image selected as an image for use in a cover, each page, or the like of a photo product item or a composite image of selected images in a layout based on layout information of a product item. Note that the composite image includes an image in which a plurality of images selected from the first image group are composed along layout information of a product item. The recommendation information includes information indicating a recommended product item, a candidate image for use in the recommended product item, or information (preview screen) regarding the arrangement of the candidate image along the layout of the recommended product item.

The image processing apparatus may be configured to decide a recommended product item according to a recommendation condition determined in advance. In a case where there is no recommended product item corresponding to the content of the group, decision may be made that there is no recommended product item. In a case where there is a recommended product item corresponding to the content of the group, images for use in the recommended product item are automatically selected from the grouped second image group, and a candidate image is created. Note that, in a case where there is no recommended product item, the creation processing of the candidate image and the provision of the recommendation information may not be brought into non-execution.

The description “creation” includes a concept of “generation”. The image processing apparatus may be configured as a single apparatus or may be configured by combining a plurality of apparatuses. For example, the image processing apparatus can be realized using one or a plurality of computers. The description “apparatus” includes concepts of “system” and “module”.

The image processing apparatus according to another aspect of the present disclosure may further comprise a first storage that stores the first image group, and the at least one processor may be configured to receive upload of the first image group from a user terminal through a network and store the first image group acquired from the user terminal in the first storage in association with user identification information. The description “store” includes a concept of “preserve”.

In the image processing apparatus according to another aspect of the present disclosure, the date-of-acquisition information of the first image group may be date-of-upload information of the first image group from the user terminal. Note that the date-of-upload information is not limited to the upload date and may be information regarding a month of upload, a year of upload, or an upload time.

In the image processing apparatus according to another aspect of present disclosure, a logic validity period of recommendation logic processing including processing of performing the decision of the recommended product item and the creation of the candidate image may be set according to the classifications of the groups, and the at least one processor may be configured to execute the recommendation logic processing only on image groups of the groups of which the date-of-acquisition information is within a duration of the logic validity period.

The image processing apparatus according to another aspect of the present disclosure may further comprise a second storage that stores the candidate image, and the at least one processor may be configured to store the candidate image created by executing the recommendation logic processing in the second storage.

The second storage may be configured as a storage device separate from the first storage or may be configured as a part of a storage area in a storage device that configures the first storage.

In the image processing apparatus according to another aspect of the present disclosure, a recommendation display validity period that determines a duration during which the recommendation information may be displayed on a user terminal is set, and the at least one processor may be configured to display the recommendation information on the user terminal only within the duration of the recommendation display validity period.

It is preferable that, in a case where the recommendation logic processing is executed within the logic validity period to create the candidate image, the image processing apparatus stores the created candidate image in the second storage until at least the recommendation display validity period ends. With this, when there is an access from the user terminal again within the recommendation display validity period, it is possible to read the candidate image from the second storage to provide the recommendation information. The image processing apparatus may be configured to determine whether or not the recommendation display validity period ends and delete the candidate image from the second storage in a case where the recommendation display validity period ends.

In the image processing apparatus according to another aspect of the present disclosure, the at least one processor may be configured to display the recommendation information on the user terminal in a case where date-of-access information on which connection to the user terminal through a network is performed is the recommendation display validity period. Note that the date-of-access information is not limited to the date of access, and may be information regarding a month of access, a year of access, or an access time.

In the image processing apparatus according to another aspect of the present disclosure, the at least one processor may be configured to control push notification about the recommendation information to a user terminal according to setting of execution or non-execution of the push notification.

It is preferable that the setting of execution (push notification on) or non-execution (push notification off) of the push notification can be performed according to a product item to be recommended. It is possible to suppress provision of excessive push notification and to realize more effective recommendation.

In the image processing apparatus according to another aspect of the present disclosure, the candidate image may be included in the recommendation information.

The candidate image included in the recommendation display on the user terminal may be a part or the whole of the candidate image for use in the recommended product item. For example, in a case where the recommended product item is a product item including a plurality of pages, such as a photo album, an image used for a cover of the photo album may be used in the recommendation display.

In the image processing apparatus according to another aspect of the present disclosure, a plurality of kinds of recommended product items may be prepared according to the classifications of the groups, number-of-images information and layout information may be determined for each of the plurality of kinds of recommended product items, and the at least one processor may be configured to select images from the second image group according to number-of-images information and layout information of the decided recommended product item for the second image group of the groups and create a composite image as the candidate image corresponding to the recommended product item using the selected images.

In the image processing apparatus according to another aspect of the present disclosure, the at least one processor may be configured to group the first image group into the one or more groups by executing first recognition processing of recognizing image content of the images included in the first image group in an image unit and second recognition processing of recognizing the content of the image group in an image group unit of the second image group.

The description “recognition” includes concepts of identification, discrimination, inference, estimation, detection, and the like. The at least one processor may be configured to execute recognition processing, for example, using a learned model in which recognition performance is obtained by machine learning represented by deep learning.

In the image processing apparatus according to another aspect of the present disclosure, the at least one processor may be configured to create an album for each date of image acquisition based on date-of-image-acquisition information associated with each image of the first image group, and image groups classified into a common event category of consecutive dates of image acquisition may be arranged into one group. Note that the date-of-image-acquisition information is not limited to the date of image acquisition, and may be information regarding a month of image acquisition, a year of image acquisition, or an image acquisition time. Note that the date of image acquisition associated with each image is, for example, a date of imaging.

The at least one processor may execute an image processing method according to another aspect of the present disclosure by executing a command recorded in a memory.

A program according to another aspect of the present disclosure causes a computer to realize processing of acquiring a first image group, processing of grouping the first image group into one or more groups according to image content of images included in the first image group, processing of deciding a recommended product item for a second image group of the grouped groups based on date-of-acquisition information of the first image group and content of the second image group of the grouped groups, processing of selecting one or more images for use in creating the recommended product item from the second image group of the groups in conformity with the decided recommended product item, and deciding a layout of the one or more selected images to create a candidate image corresponding to the recommended product item, and processing of providing recommendation information regarding the recommended product item to be created using the candidate image.

The computer may be one computer or may be a plurality of computers.

In the image processing system according to another aspect of the present disclosure, a first server, a second server, and a third server, and a fourth server as the at least one server may be included, the first server may be configured to receive the upload of the first image group from the user terminal through the network and store the first image group acquired from the user terminal in a first storage in association with the user identification information, the second server may be configured to analyze the images of the first image group, the third server may be configured to perform the decision of the recommended product item, the selection of the one or more images for use in creating the recommended product item, and the decision of the layout of the one or more selected images for the second image group of the grouped groups based on an image analysis result of the second server, the fourth server may be configured to create the candidate image corresponding to the recommended product item based on information regarding the layout and the images selected by the third server, and store the created candidate image in a second storage, and the third server may be configured to control the provision of the recommendation information to the user terminal based on date-of-access information from the user terminal.

The image may be a static image, such as a photograph or a scanned image, or may be video. The first image group may be an image group that is imaged at specific time intervals, such as continuous shooting or interval imaging. The time interval of time-series imaging of the first image group may not be constant.

### Others

The components described in the above-described embodiment and the components described in the modification examples can be suitably used in combination and some of the components can be replaced.

The present disclosure is not limited to the above-described embodiment, and various modifications can be made without departing from the spirit of the present disclosure.

### EXPLANATION OF REFERENCES

10: image processing system
12: image management server
14: image processing server
16: recommendation server
18: order reception server
22: storage
28: storage
30: network
40: production factory
50: user terminal
51: image list screen
52: folder list screen
53: in-folder image list screen
54: product item preview screen
55: order screen
110: image processing apparatus
510: image
511: image display area
512: tool bar
520: folder
521: folder display area
522: notice mark
532: in-folder image display area
536: recommendation display area
537: composite image
538: preview button
540: image
541: product item use image display area
544: purchase procedure button
546: tool bar
547: return button
548: menu button
561: search button
562: folder display button
563: home button
564: share button
565: others buttons
800: computer
802: CPU
804: RAM
806: ROM
810: storage
812: communication unit
814: input device
816: display device
818: bus
SU1 to SU6: steps of processing that is executed by user terminal
S10 to S16: steps of processing that is executed by image processing apparatus
S120 to S128: steps of processing that is executed by image management server
S144: step of processing that is executed by image processing server
S162 to S168: steps of processing that is executed by recommendation server
S182 to S188: steps of processing that is executed by order reception server
S500 to S530: steps of processing that is executed by user terminal

What is claimed is:

1. An image processing apparatus comprising:
at least one processor,
wherein the at least one processor is configured to
acquire a first image group,
group the first image group into one or more groups according to image content of images included in the first image group,
decide a recommended product item according to classifications of the grouped groups based on date-of-acquisition information of the first image group and content of a second image group of the grouped groups,
select one or more images for use in creating the recommended product item from the second image group of the groups in conformity with the decided recommended product item and decide a layout of the one or more selected images to create a candidate image corresponding to the recommended product item, and
provide recommendation information regarding the recommended product item to be created using the candidate image.

2. The image processing apparatus according to claim 1, further comprising:
a first storage that stores the first image group,
wherein the at least one processor is configured to
receive upload of the first image group from a user terminal through a network, and
store the first image group acquired from the user terminal in the first storage in association with user identification information.

3. The image processing apparatus according to claim 2,
wherein the date-of-acquisition information of the first image group is date-of-upload information of the first image group from the user terminal.

4. The image processing apparatus according to claim 1,
wherein a logic validity period of recommendation logic processing including processing of performing the decision of the recommended product item and the creation of the candidate image is set according to the classifications of the groups, and
the at least one processor is configured to execute the recommendation logic processing only on image groups of the groups of which the date-of-acquisition information is within a duration of the logic validity period.

5. The image processing apparatus according to claim 4, further comprising:
a second storage that stores the candidate image,
wherein the at least one processor is configured to store the candidate image created by executing the recommendation logic processing in the second storage.

6. The image processing apparatus according to claim 1,
wherein a recommendation display validity period that determines a duration during which the recommendation information is displayed on a user terminal is set, and
the at least one processor is configured to display the recommendation information on the user terminal only within the duration of the recommendation display validity period.

7. The image processing apparatus according to claim 6,
wherein the at least one processor is configured to display the recommendation information on the user terminal in a case where date-of-access information on which connection to the user terminal through a network is performed is the recommendation display validity period.

8. The image processing apparatus according to claim 1,
wherein the at least one processor is configured to control push notification about the recommendation information to a user terminal according to setting of execution or non-execution of the push notification.

9. The image processing apparatus according to claim 1,
wherein the candidate image is included in the recommendation information.

10. The image processing apparatus according to claim 1,
wherein a plurality of kinds of recommended product items are prepared according to the classifications of the groups,
number-of-images information and layout information are determined for each of the plurality of kinds of recommended product items, and
the at least one processor is configured to select images from the second image group according to number-of-images information and layout information of the decided recommended product item for the second image group of the groups and create a composite image as the candidate image corresponding to the recommended product item using the selected images.

11. The image processing apparatus according to claim 1,
wherein the at least one processor is configured to group the first image group into the one or more groups by executing first recognition processing of recognizing image content of the images included in the first image group in an image unit and second recognition processing of recognizing the content of the image group in an image group unit of the second image group.

12. The image processing apparatus according to claim 1,
wherein the at least one processor is configured to create an album for each date of image acquisition based on date-of-image-acquisition information associated with each image of the first image group, and
image groups classified into a common event category of consecutive dates of image acquisition are arranged into one group.

13. An image processing method that is executed by at least one processor, the image processing method comprising:
at the at least one processor,
acquiring a first image group;
grouping the first image group into one or more groups according to image content of images included in the first image group;
deciding a recommended product item for a second image group of the grouped groups based on date-of-acquisition information of the first image group and content of the second image group of the grouped groups;
selecting one or more images for use in creating the recommended product item from the second image group of the groups in conformity with the decided recommended product item and deciding a layout of the one or more selected images to create a candidate image corresponding to the recommended product item; and
providing recommendation information regarding the recommended product item to be created using the candidate image.

14. A non-transitory, tangible computer-readable recording medium which records thereon a program, when read by a computer, that causes the computer to realize:
processing of acquiring a first image group;
processing of grouping the first image group into one or more groups according to image content of images included in the first image group;
processing of deciding a recommended product item for a second image group of the grouped groups based on date-of-acquisition information of the first image group and content of the second image group of the grouped groups;
processing of selecting one or more images for use in creating the recommended product item from the second image group of the groups in conformity with the decided recommended product item and deciding a layout of the one or more selected images to create a candidate image corresponding to the recommended product item; and
processing of providing recommendation information regarding the recommended product item to be created using the candidate image.

15. An image processing system comprising:
at least one server; and
a storage,
wherein the at least one server is configured to execute processing including
receiving upload of a first image group from a user terminal through a network,
storing the first image group acquired from the user terminal in the storage in association with user identification information,
grouping the first image group into one or more groups according to image content of images included in the first image group;
deciding a recommended product item for a second image group of the grouped groups based on date-of-acquisition information of the first image group and content of the second image group of the grouped groups;
selecting one or more images for use in creating the recommended product item from the second image group of the groups in conformity with the decided recommended product item and deciding a layout of the one or more selected images to create a candidate image corresponding to the recommended product item; and
providing recommendation information regarding the recommended product item to be created using the candidate image to the user terminal.

16. The image processing system according to claim 15,
wherein a first server, a second server, and a third server, and a fourth server as the at least one server are included,
the first server is configured to receive the upload of the first image group from the user terminal through the network and store the first image group acquired from the user terminal in a first storage in association with the user identification information,
the second server is configured to analyze the images of the first image group,
the third server is configured to perform the decision of the recommended product item, the selection of the one or more images for use in creating the recommended product item, and the decision of the layout of the one or more selected images for the second image group of the grouped groups based on an image analysis result of the second server,
the fourth server is configured to create the candidate image corresponding to the recommended product item based on information regarding the layout and the images selected by the third server, and store the created candidate image in a second storage, and
the third server is configured to control the provision of the recommendation information to the user terminal based on date-of-access information from the user terminal.
